(19) United States
(12) Patent Application Publication
(10) Pub. No.: US 2015/0009240 A1
(43) Pub. Date: Jan. 8, 2015

(54) GAMMA REFERENCE VOLTAGES GENERATING CIRCUIT WITH OUTPUT OFFSET AND DISPLAY APPARATUS

(71) Applicant: INTEGRATED SOLUTIONS TECHNOLOGY INC., Taipei City (TW)

(72) Inventors: TOSHIAKI MATSUOKA, KANAGAWA-KEN (JP); CHIA CHENG LEI, NEW TAIPEI CITY (TW)

(73) Assignee: INTEGRATED SOLUTIONS TECHNOLOGY INC., Taipei City (TW)

(21) Appl. No.: 13/974,625

(22) Filed: Aug. 23, 2013

(30) Foreign Application Priority Data
Jul. 3, 2013 (TW) 102123794

(51) Int. Cl. G09G 3/32

(52) U.S. Cl. CPC G09G 3/3225
USPC 345/690; 345/83

(57) ABSTRACT

A gamma reference voltages generating circuit with output offset for controlling a gray level of a light-emitting unit is provided. The light-emitting unit includes a switch and a light-emitting element which is coupled to a bias voltage. The gamma reference voltages generating circuit includes a first gamma voltage divider and a digital-to-analog converter. The first gamma voltage divider includes a plurality of resistors. A first terminal of the first gamma voltage divider is coupled to the bias voltage, and a second terminal of the first gamma voltage divider is coupled to a reference current source. The digital-to-analog converter is coupled to the first gamma voltage divider to receive a plurality of reference voltages generated by the first gamma voltage divider. The digital-to-analog converter is controlled by a digital control signal to output one of the reference voltages to a control terminal of the switch in the light-emitting unit.

### BACKGROUND

1. Technical Field

The present disclosure relates to a gamma reference voltages generating circuit, in particular, to a gamma reference voltages generating circuit with output offset and a display apparatus.

2. Description of Related Art

The luminance of a light-emitting element such as a light emitting diode or an organic light emitting diode is directly proportional to the turn on current of the light-emitting element, but is not linear to the voltage. Therefore, in order to design proper gray level when light emitting diodes or organic light emitting diodes are applied to a display apparatus, a gamma voltage divider is generally adopted. The gamma voltage divider is used to provide a plurality of demanded reference voltages. Each reference voltage corresponds to a gray level.

Referring to FIG. 1, FIG. 1 is a circuit diagram illustrating a conventional light-emitting unit. The conventional light-emitting unit comprises a switch 15 and a light-emitting element 16. A bias voltage Vo is provided to the switch and the light-emitting element which are in series with each other. The current passing through the light-emitting element 16 can be changed by the driving signal Vc when the control terminal of the switch 15 receives the driving signal Vc.

However, the bias voltage Vo may be floated by external electrical signal interference or electromagnetic interference. When the bias voltage Vo is floated and the driving signal Vc providing to the switch 15 is unchanged, the gray level of the light-emitting element 16 will be changed due to the floating of the bias voltage Vo.

### SUMMARY

A gamma reference voltages generating circuit with output offset and a display apparatus are provided in exemplary embodiments of the present disclosure. When a bias voltage of a light-emitting unit is floated, a bias voltage of a gamma voltage divider will be floated accordingly so as to prevent that the gray level of the light-emitting unit will be changed due to the floating of the bias voltage of the light-emitting unit.

An exemplary embodiment of the present disclosure provides a gamma reference voltages generating circuit with output offset for controlling a gray level of a light-emitting unit. The light-emitting unit comprises a switch and a light-emitting element coupling to the switch. The light-emitting unit is coupled to a bias voltage. The gamma reference voltages generating circuit comprises a first gamma voltage divider and a digital-to-analog converter. The first gamma voltage divider comprises a plurality of resistors. The resistors are in series with each other and are coupled between a first terminal and a second terminal of the first gamma voltage divider. The first terminal is coupled to the bias voltage. The second terminal is coupled to a reference current source. The first gamma voltage divider generates a plurality of reference voltages. The digital-to-analog converter is coupled to the first gamma voltage divider to receive the reference voltages. The digital-to-analog converter is controlled by a digital control signal to output one of the reference voltages to a control terminal of the switch in the light-emitting unit.

An exemplary embodiment of the present disclosure provides a display apparatus. The display apparatus comprises a plurality of light-emitting units and a gamma reference voltages generating circuit. The light-emitting units are disposed in array type. The light-emitting units are coupled to a bias voltage. Each of the light-emitting units comprises a switch and a light-emitting element coupling to the switch. The gamma reference voltages generating circuit is configured to control gray levels of the light-emitting units. The gamma reference voltages generating circuit comprises a first gamma voltage divider and a digital-to-analog converter. The first gamma voltage divider comprises a plurality of resistors. The resistors are in series with each other and are coupled between a first terminal and a second terminal of the first gamma voltage divider. The first terminal is coupled to the bias voltage. The second terminal is coupled to a reference current source. The first gamma voltage divider generates a plurality of reference voltages. The digital-to-analog converter is coupled to the first gamma voltage divider to receive the reference voltages. The digital-to-analog converter is controlled by a digital control signal to output one of the reference voltages to a control terminal of the switch in each of the light-emitting units.

To sum up, the exemplary embodiments of the present disclosure provides the gamma reference voltages generating circuit with output offset and the display apparatus which provide the reference current source to the gamma voltage divider and make the bias voltage of the gamma voltage divider be coupled to the bias voltage of the light-emitting unit. Thus, when the bias voltage of the light-emitting unit is floated, the bias voltage of the gamma voltage divider is floated accordingly so as to prevent that the gray level of the light-emitting unit will be changed due to the floating of the bias voltage of the light-emitting unit.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the scope of the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a circuit diagram illustrating a conventional light-emitting unit.

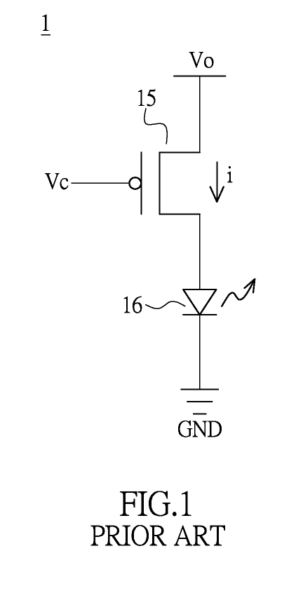

FIG. 2 is a circuit diagram illustrating a gamma reference voltages generating circuit with output offset in an embodiment of the present disclosure.

FIG. 3 is a circuit diagram illustrating a gamma reference voltages generating circuit with output offset in another embodiment of the present disclosure.

### DESCRIPTION OF THE EXEMPLARY EMBODIMENTS

An exemplary embodiment of a gamma reference voltages generating circuit with output offset and a display apparatus

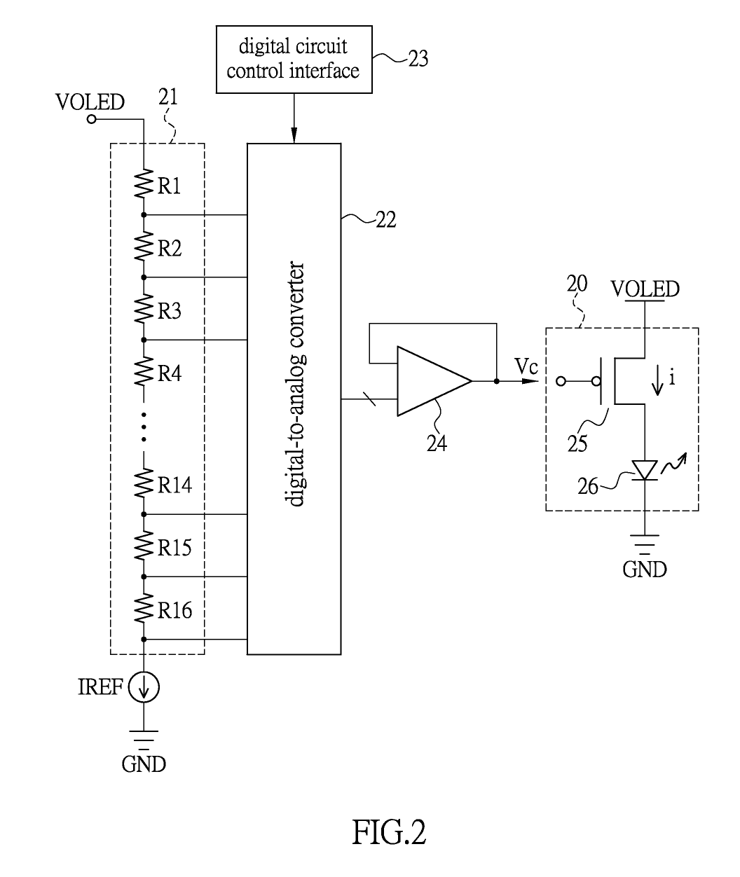

Referring to FIG. 2, FIG. 2 is a circuit diagram illustrating a gamma reference voltages generating circuit with output offset in an embodiment of the present disclosure. The gamma reference voltages generating circuit with output offset is configured to control the gray level of the light-emitting unit 20. The light-emitting unit 20 comprises a switch 25 and a light-emitting element 26 coupling to the switch 25. The light-emitting unit 20 is coupled to a bias voltage VOLED. The light-emitting element 26 is a light emitting diode such as an organic light emitting diode, but the implementation of the light-emitting element is not intended to limit the scope of the present disclosure. The gamma reference voltages generating circuit with output offset comprises a first gamma voltage divider 21, a digital-to-analog converter 22, a digital circuit control interface 23, a unit gain amplifier 24 and a reference current source IREF.

The first gamma voltage divider 21 comprises resistors R1, R2, R3, R4 . . . R14, R15 and R16. The resistors are in series with each other and coupled between the first terminal and the second terminal of the first gamma voltage divider 21. The first terminal is coupled to the bias voltage VOLED. The second terminal is coupled to the reference current source IREF. The digital-to-analog converter 22 is coupled to the first gamma voltage divider 21. The digital circuit control interface 23 is coupled to the digital-to-analog converter 22. The digital circuit control interface 23 transmits a digital control signal to the digital-to-analog converter 22. The unit gain amplifier 24 is coupled between the digital-to-analog converter 22 and the light-emitting unit 20.

The first gamma voltage divider 21 generates a plurality of reference voltages V1, V2, V3, V4 . . . V14, V15 and V16. In the present embodiment, the digital-to-analog converter 22 is a four digits converter for illustration, but is not intended to limit the scope of the present disclosure. The digital-to-analog converter 22 is coupled to the first gamma voltage divider 21 to receive the reference voltages (V1, V2, V3, V4 . . . V14, V15 and V16). The digital-to-analog converter 22 is controlled by the digital control signal from the digital circuit control interface 23 to output one of the reference voltages (V1, V2, V3, V4 . . . V14, V15 and V16) to the control terminal of the switch 25 in the light-emitting unit 20 (via the unit gain amplifier 24). In other words, the digital-to-analog converter 22 selects one of the reference voltages according to the digital control signal and outputs the selected reference voltage to the control terminal of the switch 25 in the light-emitting unit 20.

In the present embodiment, the switch 25 is a metal oxide semiconductor field effect transistor (MOSFET). The control terminal of the switch 25 is the gate. The driving signal Vc of the unit gain amplifier 24 is used to provide sufficient voltage driving capability for the control terminal of the switch 25.

It should be mentioned that since the bias voltage of the first gamma voltage divider 21 is the same with the bias voltage of the light-emitting unit 20 (i.e., both are VOLED), when the bias voltage VOLED of the light-emitting unit 20 is floated by external electrical signal interference, the reference voltages (V1, V2, V3, V4 . . . V14, V15 and V16) generated by the first gamma voltage divider 21 will be floated accordingly. Therefore, the voltage transmitted to the control terminal of the switch 25 in the light-emitting unit 20 is floated following the bias voltage VOLED of the light-emitting unit 20. In this way, the gray level of the light-emitting element 26 will not be changed by external electrical signal interference or electromagnetic interference.

According to above descriptions, in order to constitute a display apparatus, the display apparatus may comprises a plurality of light-emitting units 20. The light-emitting units 20 are disposed in array type. The light-emitting units 20 are coupled to the bias voltage VOLED. Each of the light-emitting units 20 comprises the switch 25 and the light-emitting element 26 coupling to the switch 25 as illustrated in FIG. 2. The above mentioned digital-to-analog converter 22 of the gamma reference voltages generating circuit is controlled by the digital control signal to output one of the above mentioned reference voltages (V1, V2, V3, V4 . . . V14, V15 and V16) to the control terminal (the gate in FIG. 2) of the switch 25 in each light-emitting unit 20 disposed in array type.

Another exemplary embodiment of a gamma reference voltages generating circuit with output offset and a display apparatus

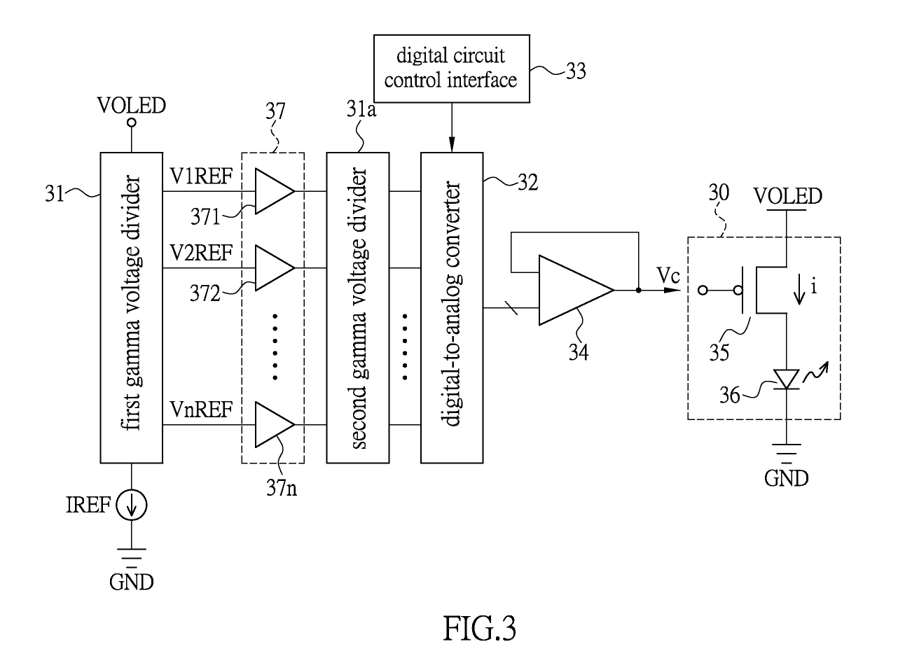

Referring to FIG. 3, FIG. 3 is a circuit diagram illustrating a gamma reference voltages generating circuit with output offset in another embodiment of the present disclosure. The gamma reference voltages generating circuit with output offset is configured to control the gray level of the light-emitting unit 30. The light-emitting unit 30 comprises a switch 35 and a light-emitting element 36 coupling to the switch 35. The light-emitting unit 30 is coupled to a bias voltage VOLED. The light-emitting element 36 is a light emitting diode such as an organic light emitting diode, but the implementation of the light-emitting element is not intended to limit the scope of the present disclosure. The gamma reference voltages generating circuit with output offset comprises a first gamma voltage divider 31, a digital-to-analog converter 32, a second gamma voltage divider 31a, a digital circuit control interface 33, a unit gain amplifier 34, a voltage buffer unit 37 and a reference current source IREF.

The first gamma voltage divider 31 comprises a plurality of resistors in series with each other which are identical to the first gamma voltage divider 21 in FIG. 2. The resistors are in series with each other and coupled between the first terminal and the second terminal of the first gamma voltage divider 31. The first terminal is coupled to the bias voltage VOLED. The second terminal is coupled to the reference current source IREF. The number of the resistors of the first gamma voltage divider 31 for voltage dividing is different from that of the first gamma voltage divider 21 in FIG. 2. In the present embodiment, the first gamma voltage divider 31 generates N reference voltages (N is a natural number) V1REF, V2REF . . . VnREF as illustrated in FIG. 3. The voltage buffer unit 37 is coupled to the first gamma voltage divider 31. The second gamma voltage divider 31a is coupled between the voltage buffer unit 37 and the digital-to-analog converter 32. The digital circuit control interface 33 is coupled to the digital-to-analog converter 32. The digital circuit control interface 33 transmits a digital control signal to the digital-to-analog converter 32. The unit gain amplifier 34 is coupled between the digital-to-analog converter 32 and the light-emitting unit 30.

In other words, the gamma reference voltages generating circuit in FIG. 3 is approximately the same with the gamma reference voltages generating circuit in FIG. 2. The only difference is the additional voltage buffer unit 37 and second gamma voltage divider 31a. The voltage buffer unit 37 comprises a plurality of buffers 371, 372 . . . 37n. Each of the buffers (371, 372 . . . 37n) receives a reference voltage (V1REF, V2REF . . . VnREF) correspondingly and transmits the reference voltages (V1REF, V2REF . . . VnREF) to the second gamma voltage divider 31a. The first gamma voltage divider 31 belongs to a front gamma circuit. The second gamma voltage divider 31a belongs to a post gamma voltage divider (used to fine tune the gamma value).

It should be mentioned that since the bias voltage of the first gamma voltage divider 31 is the same with the bias voltage of the light-emitting unit 30 (i.e., both are VOLED), when the bias voltage VOLED of the light-emitting unit 30 is floated by external electrical signal interference or electromagnetic interference, the reference voltages (V1REF, V2REF . . . VnREF) generated by the first gamma voltage divider 31 will be floated accordingly. Therefore, the voltage transmitted to the control terminal of the switch 35 in the light-emitting unit 30 is floated following the bias voltage VOLED of the light-emitting unit 30. In this way, the gray level of the light-emitting element 36 will not be changed by external electrical signal interference or electromagnetic interference.

According to above descriptions, in order to constitute a display apparatus, the display apparatus may comprises a plurality of light-emitting units 30. The light-emitting units 30 are disposed in array type. The light-emitting units 30 are coupled to the bias voltage VOLED. Each of the light-emitting units 30 comprises the switch 35 and the light-emitting element 36 coupling to the switch 35 as illustrated in FIG. 3. The above mentioned digital-to-analog converter 32 of the gamma reference voltages generating circuit is controlled by the digital control signal to output one of the above mentioned reference voltages (V1REF, V2REF . . . VnREF) to the control terminal (the gate in FIG. 3) of the switch 35 in each light-emitting unit 30 disposed in array type.

According to above descriptions, the exemplary embodiments of the present disclosure provides the gamma reference voltages generating circuit with output offset and the display apparatus which provide the reference current source to the gamma voltage divider and make the bias voltage of the gamma voltage divider be coupled to the bias voltage of the light-emitting unit. Thus, when the bias voltage of the light-emitting unit is floated, the bias voltage of the gamma voltage divider is floated accordingly so as to prevent that the gray level of the light-emitting unit will be changed due to the floating of the bias voltage of the light-emitting unit.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A gamma reference voltages generating circuit with output offset for controlling a gray level of a light-emitting unit, the light-emitting unit comprising a switch and a light-emitting element coupling to the switch, the light-emitting unit coupled to a bias voltage, the gamma reference voltages generating circuit comprising:
a first gamma voltage divider, having a plurality of resistors, wherein the resistors are in series with each other and are coupled between a first terminal and a second terminal of the first gamma voltage divider, the first terminal is coupled to the bias voltage, the second terminal is coupled to a reference current source, wherein the first gamma voltage divider generates a plurality of reference voltages; and
a digital-to-analog converter, being coupled to the first gamma voltage divider to receive the reference voltages, wherein the digital-to-analog converter is controlled by a digital control signal to output one of the reference voltages to a control terminal of the switch in the light-emitting unit.

2. The gamma reference voltages generating circuit as claimed in claim 1, wherein the light-emitting element is a light emitting diode.

3. The gamma reference voltages generating circuit as claimed in claim 1, wherein the switch is a metal oxide semiconductor field effect transistor.

4. The gamma reference voltages generating circuit as claimed in claim 1, further comprising:
a unit gain amplifier, being coupled between the digital-to-analog converter and the switch.

5. The gamma reference voltages generating circuit as claimed in claim 1, further comprising:
a voltage buffer unit, being coupled to the first gamma voltage divider; and
a second gamma voltage divider, being coupled between the voltage buffer unit and the digital-to-analog converter.

6. The gamma reference voltages generating circuit as claimed in claim 1, further comprising:
a digital circuit control interface, being configured to transmit the digital control signal to the digital-to-analog converter.

7. A display apparatus, comprising:
a plurality of light-emitting units, being disposed in array type and being coupled to a bias voltage, wherein each of the light-emitting units comprises a switch and a light-emitting element coupling to the switch; and
a gamma reference voltages generating circuit, being configured to control gray levels of the light-emitting units, comprising:
a first gamma voltage divider, having a plurality of resistors, wherein the resistors are in series with each other and are coupled between a first terminal and a second terminal of the first gamma voltage divider, the first terminal is coupled to the bias voltage, the second terminal is coupled to a reference current source, wherein the first gamma voltage divider generates a plurality of reference voltages; and
a digital-to-analog converter, being coupled to the first gamma voltage divider to receive the reference voltages, wherein the digital-to-analog converter is controlled by a digital control signal to output one of the reference voltages to a control terminal of the switch in each of the light-emitting units.

8. The display apparatus as claimed in claim 7, wherein the light-emitting element is a light emitting diode.

9. The display apparatus as claimed in claim 7, wherein the switch is a metal oxide semiconductor field effect transistor.

10. The display apparatus as claimed in claim 7, wherein the gamma reference voltages generating circuit further comprises:
a voltage buffer unit, being coupled to the first gamma voltage divider; and
a second gamma voltage divider, being coupled between the voltage buffer unit and the digital-to-analog converter.
